(19) United States
(12) Patent Application Publication
(10) Pub. No.: US 2022/0034994 A1
(43) Pub. Date: Feb. 3, 2022

(54) TIME DIFFERENCE OF ARRIVAL ESTIMATOR BASED ON A JOINT-OPTIMIZATION FORMULATION

(71) Applicant: BAE SYSTEMS Information and Electronic Systems Integration Inc., Nashua, NH (US)

(72) Inventor: Masoud Farshchian, Englewood Cliffs, NJ (US)

(21) Appl. No.: 16/943,002

(22) Filed: Jul. 30, 2020

(51) Int. Cl. G01S 5/02; G01S 5/06; G01S 5/22

(52) U.S. Cl. CPC G01S 5/0244; G01S 5/22; G01S 5/06

(57) ABSTRACT

Techniques, systems, architectures, and methods for estimating the time difference of arrival (TDOA) based on a joint-optimization formulation, the method comprising providing at least two noisy signals, y1 and y2, where the signals are measured across different antenna elements and where one signal is a delayed amplitude, scaled version of the other signal; and estimating the TDOA using an optimization formulation.

### FIELD OF THE DISCLOSURE

The following disclosure relates generally to signal processing and, more specifically, to Time Difference of Arrival (TDOA) estimation.

### BACKGROUND

Time Difference of Arrival (TDOA) estimation is a classical signal processing problem with many applications. Finding the position of a source (geo-location) based on TDOA measurements from single or spatially separated receivers has wide applications in sonar, radar, mobile communications, and sensor networks. Noisy environments render current techniques inadequate for obtaining suitably accurate measurements in certain applications. Furthermore, in some instances, the TDOA of a pulse may also require accurate estimation, which current TDOA systems and techniques fail to address.

What is needed, therefore, is a TDOA estimation system and/or technique that is well suited to low signal-to-noise ratio (SNR) signals that can also provide an accurate estimate of the TDOA of a pulse.

### SUMMARY

A Time Difference of Arrival (TDOA) estimation technique using a joint optimization formulation is herein disclosed. The technique is especially suited for low signal-to-noise ratio signals.

An optimization system and method that can be solved iteratively based on sparse priors to estimate the TDOA of a pulse for a wide span of signal-to-noise ratios is herein disclosed. The method can be used as both a multi-channel and signal channel case, depending on accuracy vs computational complexity.

An embodiment of the optimization problem is formulated herein, in Equation (3). Experimental results showing a pulse with a TDOA of 60 nanoseconds are also provided. These results show that the approach significantly outperforms traditional cross-correlation techniques.

Furthermore, while discussed primarily in the context of identification of unknown radar signatures, such techniques could also be used in wireless communications to differentiate different signals coming from different devices and in other applications where distinguishing between different signals is desired.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a flowchart describing a method of Joint Group-Sparse Denoising and Delay (JGSDD), in accordance with embodiments of the present disclosure;

FIG. 2 is a graph showing the pulse time of channels 1 and 2, as configured in table 1, by comparing amplitude to time;

FIG. 3 is a graph showing differentiation filter rise time, i.e. the derivative of the pulse shown in FIG. 2;

FIG. 4 is graph comparing amplitude to time for a noisy pulse (10 dB SNR);

FIG. 5 is a graph comparing amplitude to time for a noisy pulse (10 dB SNR) after being put through a differentiation filter;

FIG. 6 is a graph comparing amplitude to time for both an ideal pulse and an estimated pulse, using the optimization formula described here-in;

FIG. 7 is a graph comparing magnitude to digital frequency, showing the spectrum of an ideal pulse, an estimated pulse, and a noisy pulse; and

FIG. 8 is a graph comparing RMS error to SNR for cross-correlation, matched filter, and JGSDD approaches, the graph showing the difference in TDOA RMS error between the approaches.

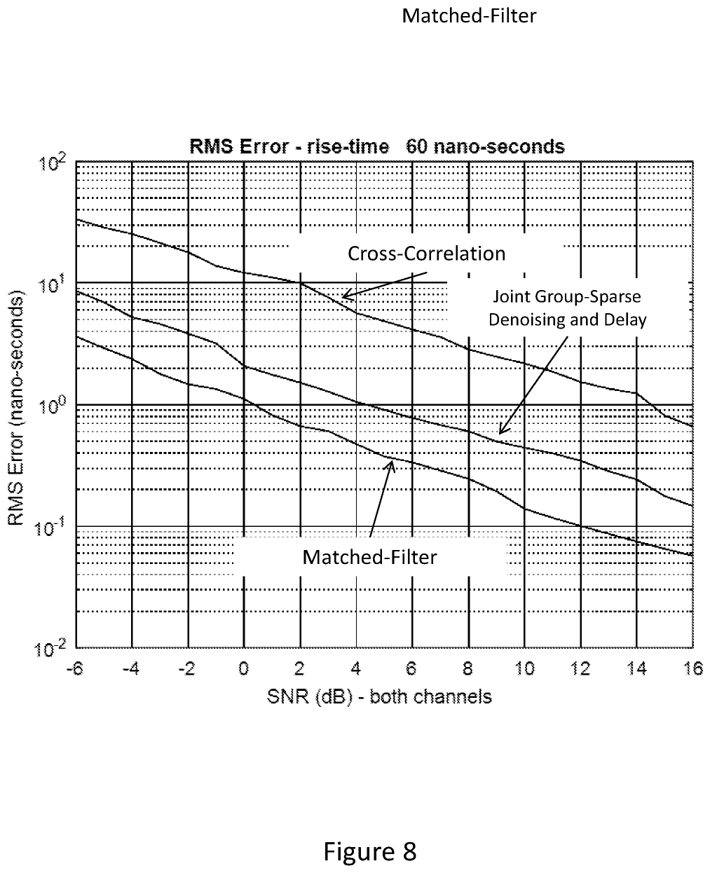

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

A variety of acronyms are used herein to describe both the subject of the present disclosure and background therefore. A brief listing of such acronyms is provided below:
ADMM—Alternating Direction Method of Multipliers;
JGSDD—Joint Group-Sparse Denoising and Delay, a method of determining TDOA based on iterative, convex optimization techniques;
NC—Non-Convex;
NC-GTVD—A more generalized form of TVD where the penalty function is non-separable and non-convex;
PDW—Pulse Descriptor Word;
PM—Pulse Repetition Interval;
RMS—Root-Mean Square;
SNR—Signal to Noise Ratio;
TOA—Time of Arrival;
TDOA—Time Difference of Arrival; and
TVD—Total Variation Denoising—A Signal Processing optimization technique that penalizes the variation of the signal in combination with its first derivative coefficients assumed to be sparse in order to estimate it.

More specifically, we disclose systems and methods involving the use of an algorithm to determine the TDOA of a pulse where there are at least two noisy signals, y₁ and y₂, measured across different antenna elements and it is assumed that that one channel is a delayed-amplitude, scaled version of the other channel. The TOA of the pulse can also be determined as a special case of the algorithm, as described below.

We use the term S^{-α} to denote a delay operator where S^{-α}y₂=ζy₂(n−α) and assume that, when there is no additive noise present, y₁=ζy₂(n−α) for some (potentially complex) amplitude scaling factor ζ and real value α. The variable α depends on the position of the target and measuring platform, the base-line, channel propagation conditions, sampling rate, waveform, frequency, and other parameters related to the overall measurement geometry. The variable n represents the sample time. In other words, we assume the model, y₁(n)=x(n)+v₁(n) and y₂(n)=ζ(S^{-α}x(n))+v₂(n), where v represents noise and interference and x represents the original transmit signal.

We consider the optimization formulation and estimate x and α from the joint data:

$${F}_{λ} \{ {y}_{1} , {y}_{2} \} = {arg min}_{x , α , K} \{ \frac{1}{2} {w}_{1} \cdot {‖ {y}_{1} - x ‖}_{2}^{2} + \frac{1}{2} {w}_{2} \cdot {‖ {y}_{2} - x ‖}_{2}^{2} + λ \cdot ( φ ( Dx ; a , K ) ) \} \qquad Equation ( 1 )$$

Here the penalty function (the regularization function), φ, a version of which is provided below, in Equation (2), can be chosen very arbitrarily, in embodiments depending on general characteristics of the data, such as the data being represented by coefficients in a filter or transform domain. As an example, the derivative of an ideal pulse is primarily zero, except for the time-sample interval consisting of its fall-time and rise-time. Consequently, embodiments model a base-band pulse to be sparse (having mostly zero or near zero values) in the difference filter domain. Alternatively, if a signal is sparse in the Fourier domain, the regularization function can be suitably chosen to model sparsity in the frequency domain.

Now regarding Equation 1, specifically, w₁, w₂, and λ, these represent weights for the data-fidelity terms and the regularization function, respectively. They may be chosen as scalars or higher dimensional vectors, when appropriate. As special cases, note in the above formulation that, when one of w₁ or w₂ is set to zero, Equation (1) reduces to the single channel estimation case. Also, if the regularization parameter is set to zero, then least square estimation is performed. The variables a and K relate to the parameters of the penalty function, as further described below, while ζ is a complex scaling factor. Extension of the optimization above to multiple channel data would be within the skill of one of ordinary skill in the art.

As a non-limiting example, we choose an appropriate penalty function to be such that it is assumed x represents data whose first order difference is sparse relative to its length with non-zero coefficients clustered together. This is a general assumption, since most pulse radars have an off period and an on period with a fall and rise-time.

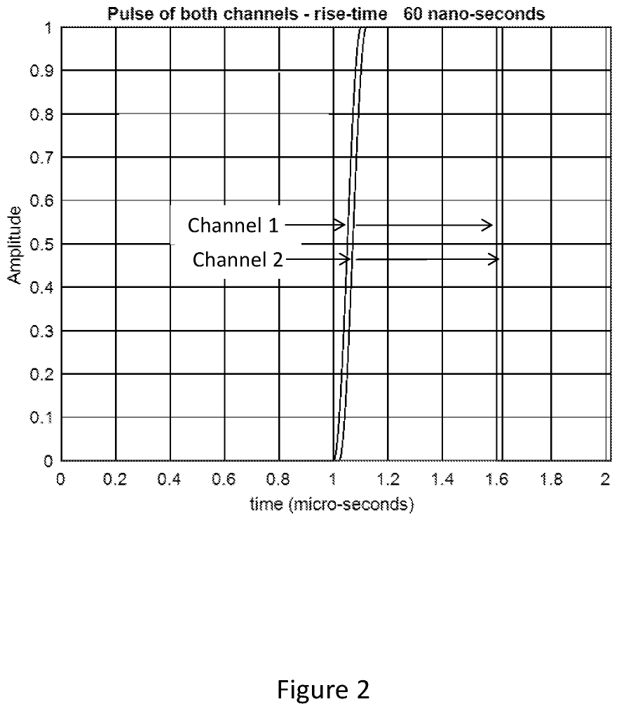

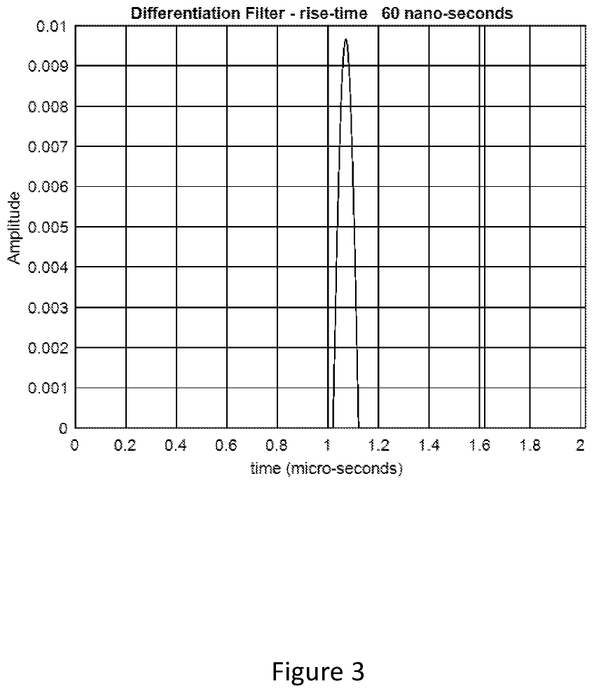

Embodiments also take into account combinations of sparsity in the first and/or higher order derivatives. For example, FIG. 2 shows a 60 nanosecond rise-time pulse (see Table 1 for parameters) for two different channels and FIG. 3 shows the derivative of the pulse. As illustrated in FIG. 3, the pulse contains non-zero coefficients during the rise-time period and also when the power on transmission switch is turned off to the radar listening mode. FIG. 3 also illustrates that, during the rise-time, the first order difference of the pulse has multiple non-zero coefficients that are clustered together. We have chosen ζ=1 for the current experiment, although other suitable values could also have been chosen.

Although it is possible to normalize the power of both channels to solve Equation (1), in some situations, it is advantageous to have the variable as part of the total optimization framework. In addition, embodiments utilize penalty functions that are non-convex.

In embodiments, non-convex penalty function with parameters such that Equation (3) is still maintained as convex due to the combination of the data-fidelity terms and other convex regularizers are used to avoid local-minima. For example, the following non-convex penalty functions (these are also referred to herein as cost functions) with over-lapping structure sparsity are used in embodiments, although many other cost functions would also be suitable, such as those described in the following texts, which are herein incorporated by reference, in their entirety:
a. Selesnick, Ivan W., and Ilker Bayram. “Sparse signal estimation by maximally sparse convex optimization.” IEEE Transactions on Signal Processing 62.5 (2014): 1078-1092; and
b. E. J. Candes, M. B. Wakin, and S. P. Boyd, “Enhancing sparsity by reweighted L1 minimization,” J. Fourier Anal. Appl., vol. 14, no. 5-6, pp. 877-905, December 2008.

Equation (2), shown below, provides a penalty function in accordance with embodiments of the present disclosure.

$$φ ( x ; a ) = {\sum }_{i = 1}^{N} \frac{2}{a \sqrt{3}} ( ( arctan \frac{1 + 2 a f ( {x}_{i} ; K )}{\sqrt{3}} ) - \frac{π}{6} ) \qquad Equation ( 2 )$$

Where f(xᵢ;K) is chosen to promote over-lapping structure sparsity and is defined as:

$$f ( {x}_{i} ; K ) = {[ {\sum }_{k = 0}^{K - 1} {\vert x ( i + k ) \vert}^{2} ]}^{\frac{1}{2}} \qquad Equation ( 3 )$$

Here f represents a sliding Euclidean norm of size K that starts at sample i up to sample K+i−1 of the estimated sampled pulse x. The notation xᵢ is used as a convention to note that the samples start at i for the estimated pulse x.

Here, f(x;K) can still be more generalized by using hamming (or other) types of weighting functions to weight the sum. Also, for K>1, we are assuming that the signal, x, has a cluster of close values. Lastly, the variable “a” promotes non-convexity allowing for more robust estimation of the signal in noise.

An alternative function is:

φ(x;a)=Σᵢ₌₁^{N}[Σₖ₌₀^{K-1}Vₖg(x(i+k);a)^{p}]^{r} Equation (4)

Where Vₖ is a window (e.g. rectangular, hamming, etc.) and g(x) is can be chosen as a convex or non-convex function, and p and r are real numbers. As an example, g(x;a) can be chosen as although not limited:

$$g ( x ; a ) = \frac{1}{\vert x \vert ( 1 + a \vert x \vert + {a}^{2} {\vert x \vert}^{2} )} \qquad Equation ( 5 )$$

Selection of the regularization function (φ(Dx; a, K) in Equation (1)) will affect performance because different regularization functions model different types of apriori knowledge about the pulse. For the example results described herein, we first define a mixed norm in Equation (6) for our penalty function.

φ_{G}(x)=Σᵢ₌₁^{N}[Σₖ₌₀^{K-1}Vₖ|x(i+k)|²]^{1/2} Equation (6)

Rather than penalizing high values of φ_{G}(x) in Equation (1), we may penalize φ_{G}(D^{m}x) where D^{m} is the m^{th} order difference operator, which can be written as a difference matrix. For m=1, D is the (N−1)×N difference matrix where the first row is [−1 1 zeros(1,N−2)]. D² is similarly defined as a (N−2)×N matrix with the first row [−1 2 −1 zeros(1,N−3)]. Each additional row is then shifted by one zero to the right, relative to the previous row. The rows of the difference matrix, D, can be written as any filter, including a notch filter.

This model takes into account that the derivative of the pulse has groups of coefficients that are clustered together and is designed to penalize large clusters of non-zero derivative coefficients. For the experimental results described herein, the first order difference penalty function φ_{G}(Dx), which penalizes a cluster of derivative coefficients, is used in Equation (1).

Now regarding Joint Group-Sparse Denoising and Delay (JGSDD) techniques, an iterative solution of Equation (1) consists of fixing α, solving Equation (1) for multiple values of α, and choosing a vector, x, such that the cost function of Equation (1) is minimized. Then, the α that corresponds to the x, that minimizes the cost function corresponds to the TDOA.

Such a solution is derived, in embodiments, by various methods including: Majorization Minimization, Proximal Methods, Forward-Backward Splitting, and other non-linear, convex optimization techniques. An algorithm using Majorization-Minimization (denoted by joint group-sparse denoising and delay (JGSDD) estimator representing an embodiment of the present invention is presented below to measure the TDOA and TOA from the output of multiple channels (Figueiredo, Mario A T, et al. “On total variation denoising: A new majorization-minimization algorithm and an experimental comparison with wavelet denoising.” 2006 International Conference on Image Processing. IEEE, 2006). Each estimate of x at each iteration L, is denoted by x^{(L)}. Here, we assume that the SNR for both channels are similar; if they are estimated to be different, then the coefficient vectors of w₁ and w₂ can be set to a function of the SNR that is linear or quadratic or another arbitrary function designed to emphasize the higher SNR channel relative to the lower SNR channel.

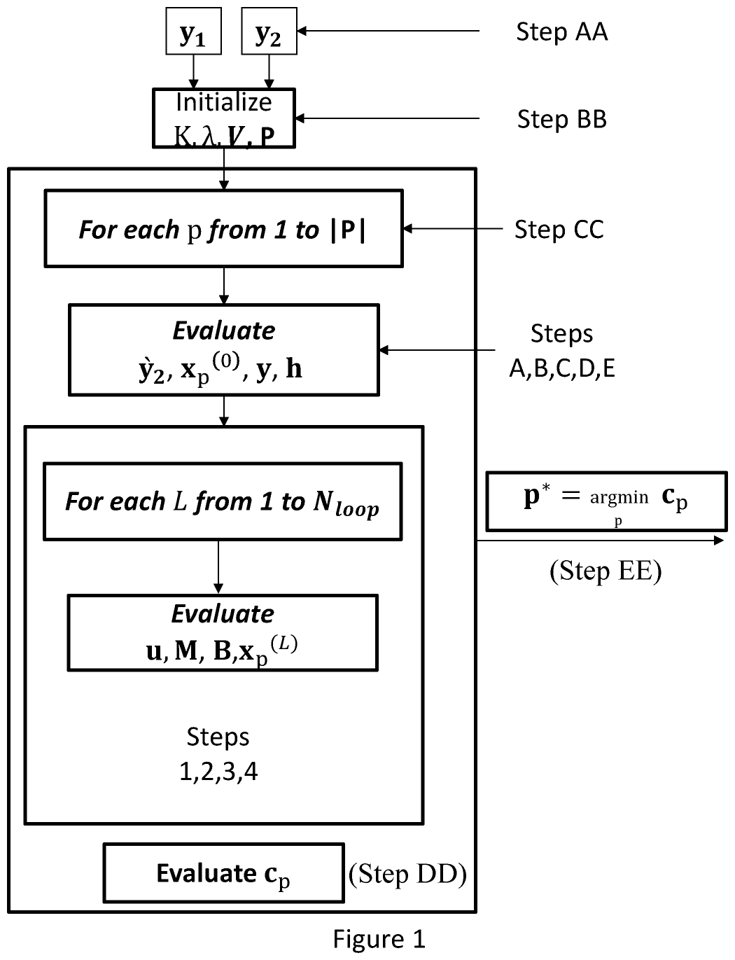

Now referring to FIG. 1, a method of JGSDD is described. More specifically, the method comprises:

Step AA) Obtain: y₁, y₂, where y₁ and y₂ are noisy, base-band samples of a pulse;

Step BB) Initiliaze the values of K, λ, V, P, where K initializes a group over-lap parameter, λ is a regularization parameter, V is a weighting vector that represents uniform, hamming, hanning, or other types of weighting parameters used in the regularization function of Equation (6), P represents a set of P delay values such that T={τ₁, τ₂ . . . τ_{P}}, and to initialize the value of a variable means to set the vector or scalar to a specific value. Note that we assume that α is either in T or there is a close value in T that approximates α to a desired accuracy.

Step CC) Outer loop: For each feasible value of τₚ indexed by p from 1 to P (where p represents an index for the delay values);

Step A) Shift y₂ by τₚ sample delays, which, mathematically, can be expressed as ý₂=y₂ (n−τₚ) and where shifting a variable by another variable means to shift the samples of a signal by moving the signal to the left or right along a discrete time axis;

Step B) Initialize the value of L=0 (where l represents the current iteration of the loop);

Step C) Set xₚ⁽⁰⁾=0.5*(y₁+ý₂), where xₚ^{(L)} represents the estimate of x at the Lth iteration); Here we have averaged the shifted value y₂ derived from step A with that of y₁. This is done so that the best candidate estimate of x can be estimated from the two independent measurements.

Step D) Set y=xₚ⁽⁰⁾ (Initialization Parameter);

Step E) Set h=D^{T}y (Initialization Parameter)

Step F) Inner Loop: Repeat until convergence for L=1: Nₗₒₒₚ

Step 1) Set u=Dxₚ^{(L-1)}, where D is the first order difference operation and u is a temporary variable used in the optimization);

Step 2) [M]_{n,n}=Σⱼ₌₀^{K-1}[Σₖ₌₀^{K-1}|Vₖu(n−j+k)|²]^{-0.5}, where u is weighted by a window Vₖ, in embodiments rectangular, hamming, hanning, etc.;

Step 3)

$$B = \frac{1}{λ} {M}^{- 1} + D {D}^{T} ,$$

where B is a constant Matrix;

Step 4) xₚ^{(L)}=y−D^{T}(B⁻¹h);

Finish Inner Loop Step F:

Step DD) Evaluate cₚ^{(L)}={½∥y₁−x∥₂²+½∥ý₂−x∥₂²+λ(φ_{G}(Dxₚ))}

Finish Outerloop from step CC:

Final Output is then provided in Step EE, below:

Step EE)

$${x}_{{p}^{*}} = {arg min}_{p} {c}_{p} ,$$

from the set of cₚ where p represents different delay values τ_{P}, choose the index p* that corresponds to the minimum value of cₚ. Then p* corresponds to the estimated TDOA.

It should be noted that, for the integer value Nₗₒₒₚ, one can choose a tolerance value that evaluates the successive difference of the solution obtained in the current inner loop xₚ^{(L)} relative to the previous inner loop xₚ^{(L-1)} for a norm such as the L2 norm. Alternatively, one can choose a number of iterations Nₗₒₒₚ based to run the iterative optimization solution a priori. Yet another method is to evaluate the difference of cₚ^{(L-1)} as function of successive values of L for a norm, such as the L2 norm. Other methods to evaluate convergence to a unique solution would also be known to those knowledgeable of the arts.

Once xₚ* is estimated, then we may estimate the TDOA of p* which corresponds to the estimated optimal delay α.

Now regarding the special case of single channel estimation and TOA estimation, Although various methods and definitions exist for TOA and its measurement, to estimate the TOA for single pulse, here we provide a simple definition of measuring the TOA at the 0.5 amplitude levels of the peak. Other common reference levels such as 0.8 or 0.9 amplitude levels can also be chosen in parallel for better estimation and feature classification of pulses, as needed.

One technique of estimating TOA, we can use Equation (1), by setting w₂=0, so that one can estimate TOA from x₁. Similarly, by setting w₁=0, one can get an estimate the TOA of x₂ and then use this estimate to estimate TDOA by taking the difference between the two estimated TOAs.

Alternative, by estimating x₁ (by setting w₂=0) and x₂ (by setting w₁=0) individually, we can also estimate the TDOA. This estimate can be used to reduce the number of candidate delays.

In general, this method utilizes both data-sets independently and, theoretically, should not perform as well as joint-decoding. This method, however, has the advantage of not requiring an optimization to be solved for each a and provides results that are still significantly better than traditional cross-correlation techniques. The computational cost is also reduced significantly by the number of candidate delays that are used to solve Equation (1).

One method to speed up the joint estimation process of embodiments is to solve the single channel to obtain a narrower range of candidate delay values. Another method is to use parallelization, since each candidate delay lends itself to a different optimization program.

Now regarding obtaining the solution of the optimization, a variety of approaches including ADMM, Proximal Splitting Methods, Majorization Minimization, brute-force search, and others, as would be known to one of ordinary skill in the art, can be used to solve Equation (1). These and other approaches can be found described in the following texts, which are herein incorporated by reference, in their entirety: Afonso, Manya V., José M. Bioucas-Dias, and Mário AT Figueiredo. “An augmented Lagrangian approach to the constrained optimization formulation of imaging inverse problems.” IEEE Transactions on Image Processing 20.3 (2011): 681-695; Combettes, Patrick L., and Jean-Christophe Pesquet. “Proximal splitting methods in signal processing.” Fixed-point algorithms for inverse problems in science and engineering. Springer, New York, N.Y., 2011. 185-212; and Figueiredo, Mário A T, José M. Bioucas-Dias, and Robert D. Nowak. “Majorization-minimization algorithms for wavelet-based image restoration.” IEEE Transactions on Image processing 16.12 (2007): 2980-2991.

It should be noted that, given the filter operations are banded matrices, the solution of Equation (1) can, in general, involve banded matrixes, which are efficient from a numerical computational implementation.

Now regarding our sample experimental result, we illustrate the aforementioned methods and systems that make use of them by the following TDOA experiment, which is tabulated in Table 1, below.

The algorithm shown below can be used for TDOA where there are at least two noisy signals, y₁ and y₂, measured across different antenna elements and it is assumed that one channel is a delayed amplitude, scaled version of the other channel. In other words, y₁(n)=x(n)+v₁(n) and y₂ (n)=∈x(n−τ)+v₂ (n)

### Special Case: Single Channel Estimation and Cross-Correlation

Using Equation (1), by setting w₂=0, one can estimate x; similarly, by setting w₁=0, one can estimate x(n−τ) and then estimate the TDOA using cross-correlation. In embodiments, this method uses both data-sets independently and should not perform as well as the joint-decoding. This method, however, does not need to solve an optimization for each a and can provide results that are still significantly better than traditional cross-correlation techniques. The computational cost is also significantly reduced by the number of candidate delays (i.e. the search space for the delay between the signals of the two channels) that are used to solve Equation (1).

This method can also serve as a pre-processing step for the joint optimization method by bounding the range that encompasses for the actual value of τ. After such a bound is produced, one can use the joint decoding method. Following this procedure, the number of candidate delays in the JGSDD is reduced, therefore reducing the convergence time of the algorithm.

### Sample Experimental Result

We illustrate the above approach by the following TDOA experiment tabulated in Table 1:

TABLE 1
Parameters of the TDOA experiment

| | | | Sampling | Signal-to- |
|---|---|---|---|---|
| Rise-time | Delay | Pulse-Width | Rate | Noise Ratio (dB) |
| 60 nano- | 0.02 micro- | 0.5994 micro- | 1600 MHz | [−6:16] dB |
| seconds | seconds | seconds | | |

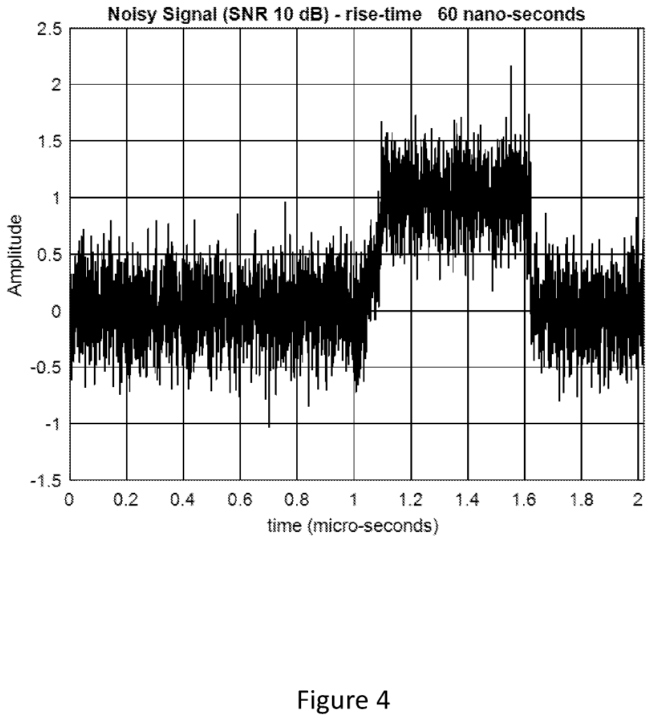

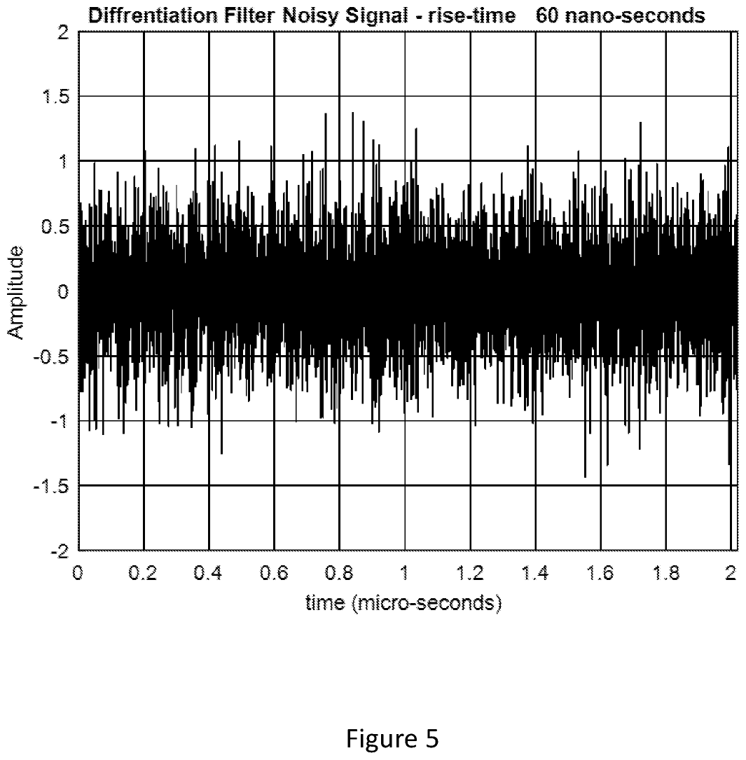

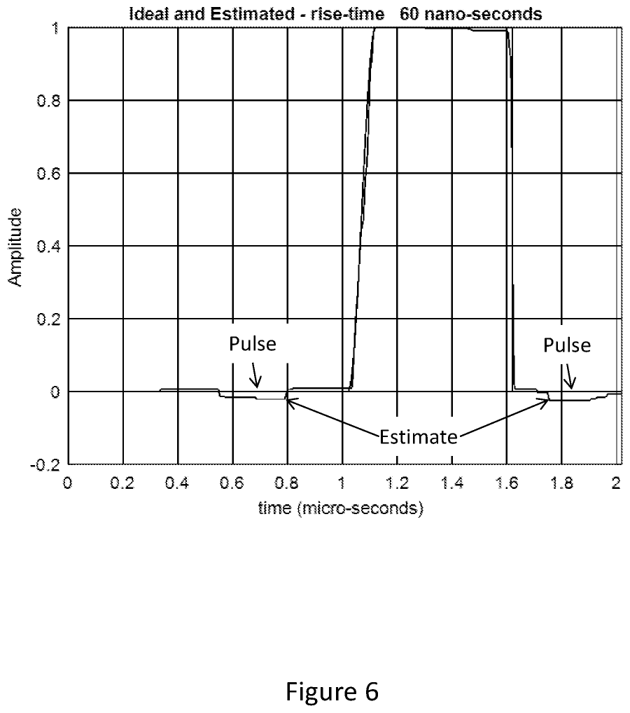

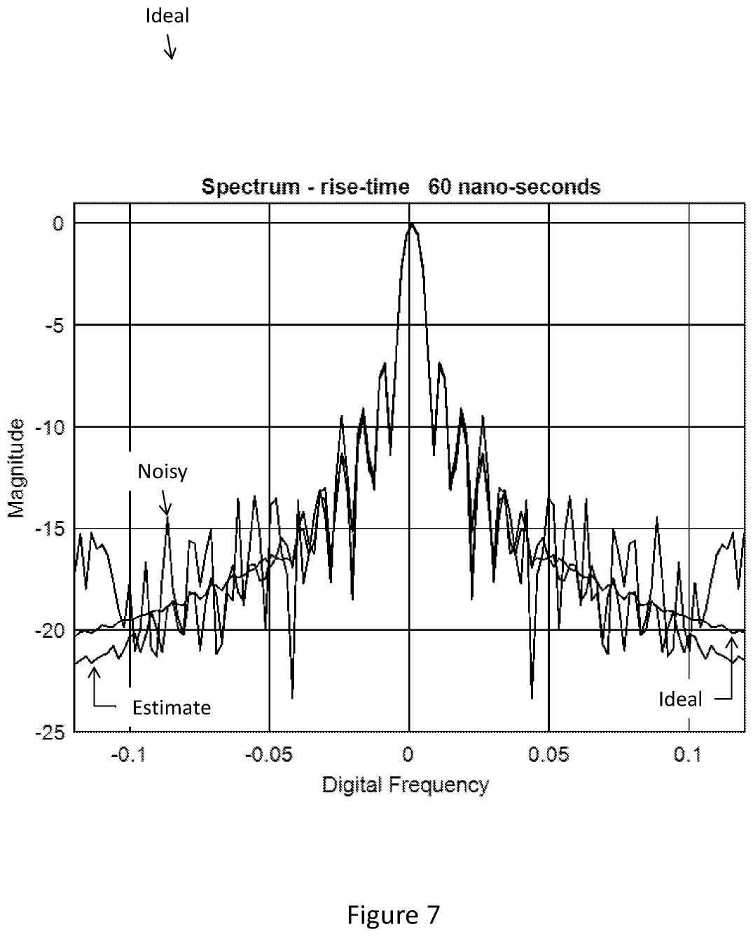

FIG. 2 illustrates the pulse on both channels with a relative delay based on the parameters tabulated in Table 1. FIG. 3 shows that the derivative coefficients of the pulse are group-sparse. When noise is added to the pulse (see FIG. 4 for 10 dB Signal-to-Noise Ratio), however, the differentiation filter does not produce a sparse output (FIG. 5). FIG. 6 shows the recovered pulse using the optimization formulation of Equation (1) and an instantiation of its solution, which is the JGSDD algorithms. FIG. 7 shows the estimated pulse, ideal pulse and noisy pulse spectra.

It can be seen that, after the application of the JGSDD algorithm, the output of the JGSDD estimates both the lower and higher frequency content of the ideal pulse more than 20 dB below the peak of the ideal spectrum; this is due to its non-linear filter.

Finally, FIG. 7 shows the TDOA of the matched-filter cross-correlation output (when the ideal pulse is known), the cross-correlation output (when the noisy pulse 1 is correlated with the noisy pulse 2), and the TDOA method obtained with the JGSDD for 200 Monte-Carlo runs with SNR step-size of 1 starting from −6 dB. It should be noted that the parameters of JGSDD were not optimized with respect to the group-size, but a group-size of K=4 (see Equation (6)) was chosen that performed significantly better than cross-correlation for pulses with 10 to 600 nanoseconds rise-times.

For example, for the output of Table 1, at an SNR of −6 dB for both channels, the ideal matched-filter TDOA output has an RMS error of 3.63 nanoseconds, the cross-correlation of both pulses provides a RMS error of 33.46 nanoseconds, and the new approach yields an RMS error of 8.60 nanoseconds. Similarly, at 10 dB, the new approach yields a TDOA RMS error of 0.44 nanoseconds, the matched-filter output yields a TDOA RMS error of 0.14 nanoseconds, and the traditional cross-correlation yields a TDOA RMS error of 2.17 nanoseconds.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A method of estimating the time difference of arrival based on a joint-optimization formulation, the method comprising:
providing at least two noisy signals, y₁ and y₂, where the signals are measured across different antenna elements and where one signal is a delayed amplitude, scaled version of the other signal; and
using the following optimization formulation:
$${F}_{λ} \{ {y}_{1} , {y}_{2} \} = {arg min}_{x , τ , ϵ , K} \{ \frac{1}{2} {w}_{1} \cdot {‖ {y}_{1} - x ‖}_{2}^{2} + \frac{1}{2} {w}_{2} \cdot {‖ {y}_{2} - x ‖}_{2}^{2} + λ \cdot ( φ ( Dx ; a , K ) ) \}$$
solving for x and a using an iterative process.

2. The method of claim 1, wherein the penalty function is a convex penalty function.

3. The method of claim 1, wherein the penalty function is a non-convex penalty function.

4. The method of claim 1, wherein a power of the noisy signals is normalized before solving for x and a.

5. The method of claim 1, wherein the following cost function is used in the optimization formulation:
$$φ ( x ; a ) = {\sum }_{i = 1}^{N} \frac{1}{a} ( log ( 1 + a \vert f ( {x}_{i} ; K ) \vert ) ) .$$

6. The method of claim 1, wherein the following cost function is used in the optimization formulation:
$$φ ( x ; a ) = {\sum }_{i = 1}^{N} \frac{1}{a} ( log ( 1 + a \vert f ( {x}_{i} ; K ) \vert ) )$$
and wherein f(xᵢ;K) is chosen to promote over-lapping structure sparsity and is defined as:
$$f ( {x}_{i} ; K ) = {[ {Σ}_{k = 0}^{K - 1} {\vert x ( i + k ) \vert}^{2} ]}^{\frac{1}{2}} .$$

7. The method of claim 6, wherein f(xₗ;K) is further generalized by using weighting functions to weight a sum.

8. The method of claim 7, wherein the weighting functions are hamming type functions.

9. The method of claim 1, wherein the following cost function is used in the optimization formulation: φ(x;a)=Σᵢ₌₁^{N}[Σₖ₌₀^{K-1}Vᵢg(x(i+k);a)^{p}]^{r}

10. The method of claim 1, further comprising defining a mixed norm in the following equation: φ_{G}(x)=Σᵢ₌₁^{N}[Σₖ₌₀^{K-1}Vₖ|x(i+k)|²]^{1/2}.

11. The method of claim 1, further comprising penalizing φ_{G}(D^{l}x) where D^{l} is the lth order difference operator.

12. The method of claim 1 wherein the iterative process comprises:
fixing τ;
solving the optimization formulation for multiple values of τ; and
choosing a vector x such that a cost function of the optimization formulation is minimized.

13. The method of claim 12 wherein solving the optimization formulation is accomplished using a technique selected from the group consisting of: majorization, proximal methods, and non-linear convex optimization for each fixed τ.

14. The method of claim 13 further comprising estimating the TDOA of a pulse once x is estimated.

15. The method of claim 1 further comprising estimating the TDOA of a pulse once x is estimated.

16. The method of claim 1 wherein estimating x comprises setting w₂=0

17. The method of claim 1 further comprising estimating x(n−τ) by setting w₁=0 and, subsequently, estimating a time difference of arrival between the two signals using cross-correlation techniques.
